(19) United States
(12) Patent Application Publication
(10) Pub. No.: US 2015/0375447 A1
(43) Pub. Date: Dec. 31, 2015

(54) FIBER STRUCTURE FORMING APPARATUS

(71) Applicant: MURATA MACHINERY, LTD., Kyoto-shi (JP)

(72) Inventors: Ryosuke TAHARA, Kyoto-shi (JP); Tadashi UOZUMI, Gifu-shi (JP); Akio OHTANI, Gifu-shi (JP)

(73) Assignees: MURATA MACHINERY, LTD., Kyoto-shi (JP); Gifu University

(21) Appl. No.: 14/750,915

(22) Filed: Jun. 25, 2015

(30) Foreign Application Priority Data
Jun. 27, 2014 (JP) 2014-133242

(51) Int. Cl. B29C 65/02; B29C 65/00

(52) U.S. Cl. CPC B29C 65/02; B29C 66/50; B29C 66/70

(57) ABSTRACT

A fiber structure forming apparatus includes a winding device, a tension applying device that applies tension to a fiber bundle that runs from the winding device to a core material, and a heating device that fuses thermoplastic resin bonded to the fiber bundle in a predetermined heating area in which the tension of the tension applying device acts on the fiber bundle.

### BACKGROUND OF THE INVENTION

1. Field of the Invention

The present invention relates to a fiber structure forming apparatus.

2. Description of the Related Art

Conventionally, a device disclosed in Patent Document 1 (see Japanese Unexamined Patent Application Publication No. 1995-9597) is such that, after fiber bundles coated by or impregnated with thermoplastic resin are wound around the outer circumferential surface of a core material, the thermoplastic resin is fused, and the fiber bundles are pressed by a metal mold, thereby forming a fiber structure from the fiber bundles.

However, every time the target shape or the target size of the fiber structure is changed, the shape of the metal mold needs to be changed in accordance with the above-mentioned change of the fiber structure, which is troublesome.

Also, fibers constituting the fiber bundles are not closely adjacent to each other, and there are gaps between the fibers. Accordingly, when the thermoplastic resin is fused, the fused thermoplastic resin flows into the gaps, and areas where the thermoplastic resin originally exists become empty. As a result, the fiber bundles have spaces in a spongy state, which causes gaps between the fiber bundles and the outer circumferential surface of the core material. Regarding the device in disclosed Patent Document 1, there is apprehension in that the fiber bundles are pressed with the metal mold in the above-mentioned state, which causes creases on the fiber structure.

### SUMMARY OF THE INVENTION

It is an object of the present invention to provide a fiber structure forming apparatus that can form a fiber structure without a metal mold and easily form the fiber structure.

According to one aspect of the present invention, a fiber structure forming apparatus may include a winding device configured to wind a fiber bundle, to which thermoplastic resin is bonded, around an outer circumferential surface of a core material, a tension applying device, when the fiber bundle is wound around the outer circumferential surface of the core material by the winding device, configured to apply tension to the fiber bundle that runs from the winding device to the core material, and a heating device configured to fuse the thermoplastic resin bonded to the fiber bundle in a predetermined heating area in which the tension of the tension applying device acts on the fiber bundle.

According to another aspect of the present invention, the heating area may be an area inclusive of a destination position, at which the fiber bundle supplied from the winding device reaches the outer circumferential surface of the core material, and a periphery of the destination position.

According to another aspect of the present invention, the winding device may be any of a braider, a hoop winding device of a filament winding device, or a helical winding device of the filament winding device.

According to another aspect of the present invention, the thermoplastic resin bonded to the fiber bundle may be fused by the heating device in the heating area, and a compaction force, with which the fiber bundle is fastened on the outer circumferential surface of the core material by means of the tension of the tension applying device, may be applied to the fiber bundle in the heating area, thereby forming a fiber structure from the fiber bundle.

According to another aspect of the present invention, the fiber structure forming apparatus may include a tape-member winding device configured to wind a tape member around the outer circumferential surface of the fiber structure in a predetermined winding area in which the thermoplastic resin impregnated in the fiber structure is fused.

### ADVANTAGEOUS EFFECTS OF THE INVENTION

The present invention provides the following advantageous effects.

According to one aspect of the present invention, the thermoplastic resin is fused in the heating area, so that when the thermoplastic resin is fused, and the fiber bundle is impregnated with the fused thermoplastic resin, the compaction force can be applied to the fiber bundle. The compaction force means a fastening force with which the fiber bundle is fastened on the outer circumferential surface of the core material by means of the tension of the tension applying device. Accordingly, the fiber structure can be formed without using a metal mold, and the fiber structure can be easily formed.

According to another aspect of the present invention, the thermoplastic resin is fused in the area inclusive of the destination position and the periphery of the destination position, so that when the thermoplastic resin is fused, and the fiber bundle is impregnated with the fused thermoplastic resin, the compaction force can be applied to the fiber bundle. Accordingly, the fiber structure can be formed without using a metal mold, and the fiber structure can be easily formed.

According to another aspect of the present invention, when the fiber bundle is wound around the outer circumferential surface of the core material by use of any of the braider, the hoop winding device of a filament winding device, or the helical winding device of the filament winding device, and the thermoplastic resin is fused, and the fiber bundle is impregnated with the fused thermoplastic resin, the compaction force can be applied to the fiber bundle. Accordingly, the fiber structure can be formed without using a metal mold, and the fiber structure can be easily formed.

According to another aspect of the present invention, the fiber structure can be formed without using a metal mold, and the fiber structure can be easily formed.

According to another aspect of the present invention, the tape member is wound around the outer circumferential surface of the fiber structure, and the outer circumferential surface of the fiber structure can be arranged in a flat form. Furthermore, the tape member is wound around the outer circumferential surface of the fiber structure, so that the fiber structure can be steadily impregnated with the thermoplastic resin, thereby making it possible to steadily suppress the emergence of air bubbles or portions, in which the fiber structure is not impregnated with the thermoplastic resin, in the interior of the fiber structure.

### BRIEF DESCRIPTION OF THE DRAWINGS

FIG. 1 is a side view of a braider.

FIG. 2 is a front view of the braider.

FIG. 3 is a view illustrating a bobbin carrier.

FIG. 4 is a view illustrating a fiber bundle.

FIG. 5 is a schematic constitutional view illustrating a first embodiment of a fiber structure forming apparatus.

FIG. 6A is a view illustrating a tape-member winding device. FIG. 6B is a cross-sectional view of a fiber structure around which a tape member is wound.

FIG. 7 is a view illustrating a state where the tape member is wound around the outer circumferential surface of the fiber structure by use of a new heating device and the tape-member winding device.

FIG. 8 is a side view of a filament winding device.

FIG. 9 is a front view of a hoop winding device and a schematic constitutional view illustrating a second embodiment of the fiber structure forming apparatus.

FIG. 10 is a schematic constitutional view illustrating the second embodiment of the fiber structure forming apparatus.

FIG. 11 is a front view of a helical winding device and a schematic constitutional view illustrating a third embodiment of the fiber structure forming apparatus.

FIG. 12 is a schematic constitutional view illustrating the third embodiment of the fiber structure forming apparatus.

### DETAILED DESCRIPTION OF THE PREFERRED EMBODIMENTS

### First Embodiment

A fiber structure forming apparatus 1, which is a first embodiment of a fiber structure forming apparatus, will be described.

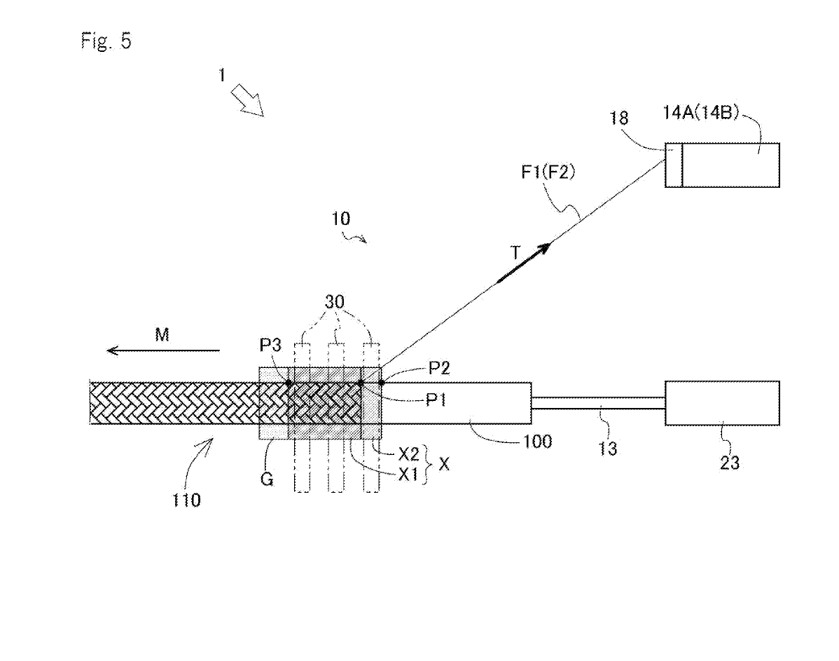

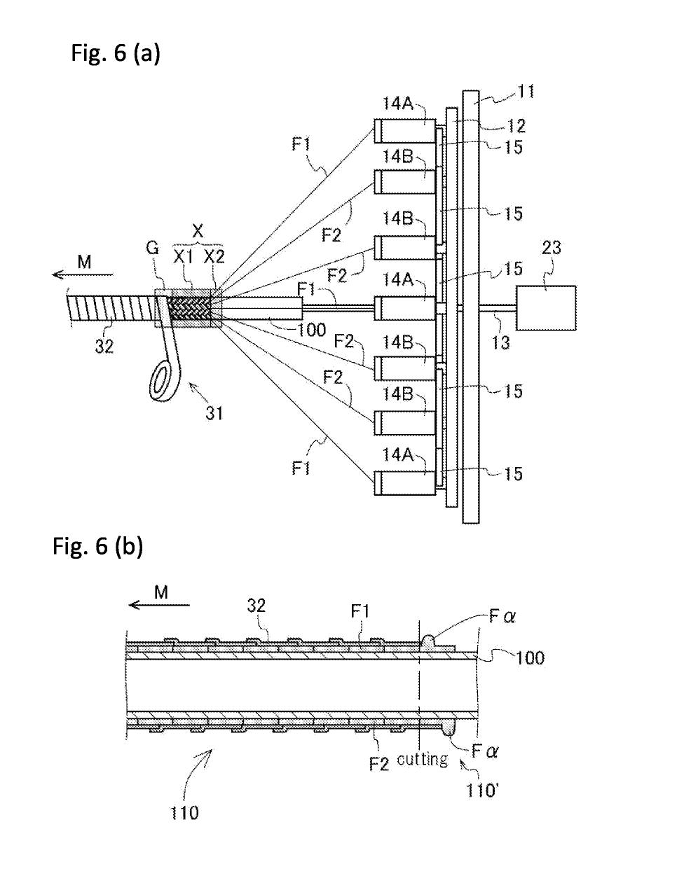

The fiber structure forming apparatus 1 includes a braider 10, a tension applying device 18, a heating device 30 (see FIG. 5), and a tape-member winding device 31 (see FIG. 6(a)).

First, the braider 10 will be described.

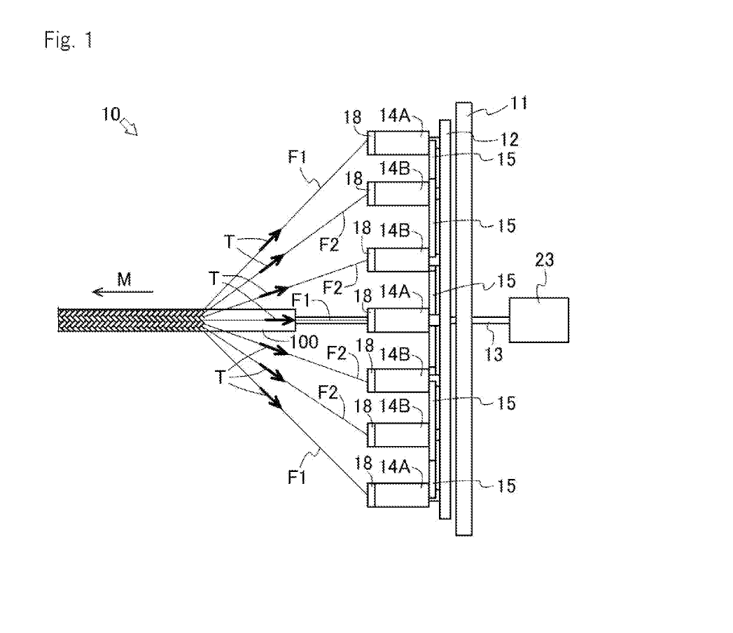

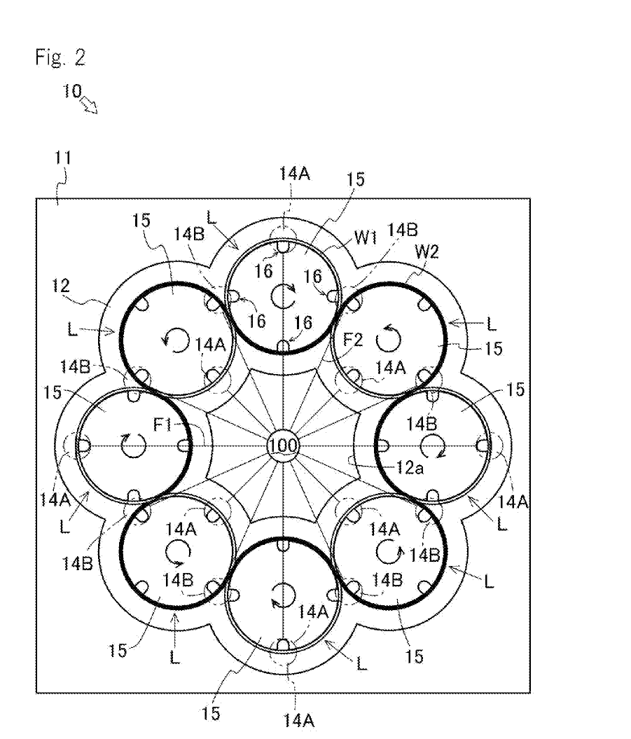

As illustrated in FIGS. 1 and 2, the braider 10 includes a frame 11 and a supporting member 12.

The supporting member 12 is fixed on the frame 11. The supporting member 12 is formed in a tubular shape and has a hole 12a in the center thereof. A tubular core material 100 is arranged opposite to the hole 12a of the supporting member 12. The core material 100 is connected to a transfer device 23 via a supporting shaft 13. The transfer device 23 transfers the core material 100 in the axial direction M. In the present embodiment, it is constituted that the core material 100 is transferred in the axial direction M, but the present invention is not limited to this. It may be constituted that the supporting member 12 is transferred in the axial direction M.

As illustrated in FIG. 2, running tracks W1 and W2 are provided on the surface of the supporting member 12. The running tracks W1 and W2 are grooves, which constitute the running paths of bobbin carriers 14A and 14B. The running tracks W1 and W2 are formed in an annular shape in such a manner as to surround the hole 12a of the supporting member 12. The pair of running tracks W1 and W2 are constituted in such a manner as to be periodically intersected. Also, the entire shape of the running tracks W1 and W2 intersecting with each other is made up of a plurality of rings L coupled and contiguously arranged about the axis of the core material 100.

Impellers 15 are arranged on the inner side of the rings L. The impellers 15 are rotatably supported in the circumferential direction of the rings L. A plurality of notch portions 16 engageable with the bobbin carriers 14A and 14B are formed at the edge portions of the impellers 15. In the present embodiment, four notch portions 16 are provided at intervals of 90 degrees in the circumferential direction of the rings L. A gear (not illustrated) is coupled with each impeller 15, and the gears of the impellers 15 adjacently arranged are meshed with each other. A drive device (motor) is connected to one of the gears, and the drive device is activated, and all of the gears are rotated, and the impellers 15 synchronously rotate in response to the rotation of the gears. It is noted that the impellers 15 adjacently arranged rotate in opposite directions to each other (see FIG. 2). Respective bobbin carriers 14A and 14B are engaged with the notch portion 16 of the impeller 15, and the impeller 15 is rotated, whereby the bobbin carrier 14A (14B) runs along the running track W1 (W2).

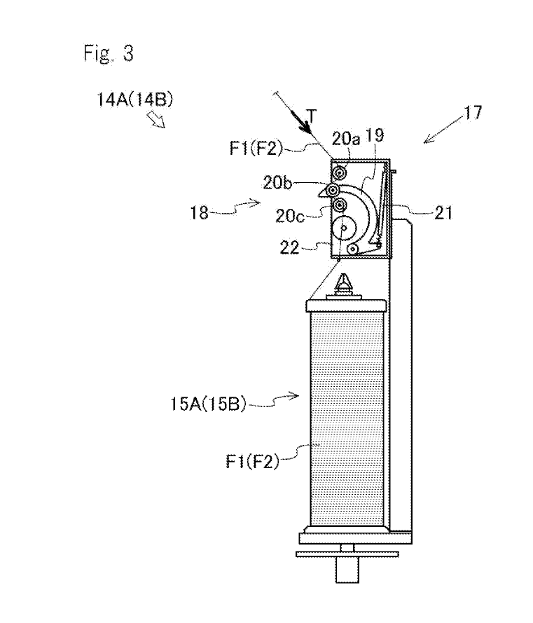

As illustrated in FIG. 3, a bobbin 15A (15B) is mounted on each bobbin carrier 14A (14B). A fiber bundle F1 (F2) is wound around each bobbin 15A (15B). A guide portion 17 that guides the fiber bundle F1 (F2) on each bobbin 15A (15B) is provided on each bobbin carrier 14A (14B). The fiber bundle F1 (F2) is drawn out from each bobbin carrier 14A (14B) via each guide portion 17.

As illustrated in FIG. 3, the tension applying device 18 that applies tension T to the fiber bundles F1 and F2 is provided on each guide portion 17. The tension applying device 18 includes a main body 19, roller guides 20a, 20b, and 20c, and a coil spring 21. The main body 19 has a curved shape and is rotatably mounted on a frame 22. A second roller guide 20b is mounted at the tip end of the main body 19. One end of the coil spring 21 is mounted on the base end of the main body 19. The other end of the coil spring 21 is mounted on the frame 22. The second roller guide 20b is biased by the coil spring 21 in a counterclockwise direction in FIG. 3. The first roller guide 20a is provided on the upstream side of the second roller guide 20b, and the third roller guide 20c is provided on the downstream side of the second roller guide 20b. The roller guides 20a and 20b are mounted on the frame 22. The fiber bundle F1 (F2) is wound around the roller guides 20a, 20b, and 20c. The second roller guide 20b is biased by the coil spring 21 in the counterclockwise direction, so that the tension T is applied to the fiber bundle F1 (F2) in the direction opposite to the running direction of the fiber bundle F1 (F2), which runs from the braider 10 to the core material 100. Accordingly, this prevents the fiber bundle F1 (F2) from slackening. The tension T has the degree of intensity in accordance with the biasing force of the coil spring 21. It is noted that the tension applying device 18 is not limited to the present embodiment. Regarding the braider 10, each tension applying device 18 applies the tension T to the respective fiber bundles F1 and F2 while the respective fiber bundles F1 and F2 are wound around the outer circumferential surface of the core material 100 (see FIG. 1).

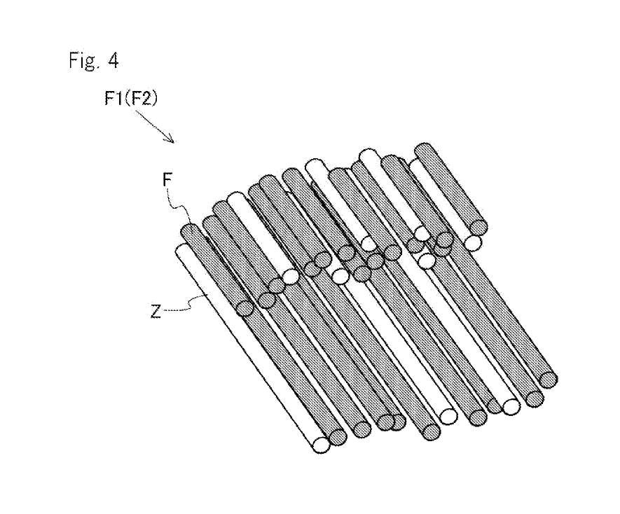

The fiber bundles F1 and F2 are fiber bundles made of glass fibers, aramid fibers, carbon fibers, and the like. The thermoplastic resin (for example, polyethylene resin) is bonded to the fiber bundles F1 and F2. States where the thermoplastic resin is bonded to the fiber bundles F1 and F2 include (i) a state where the fiber bundles F1 and F2 are impregnated with the thermoplastic resin, (ii) a state where the fiber bundles F1 and F2 are coated with the thermoplastic resin, and (iii) a state where resin fiber bundles Z continuously made up of the thermoplastic resin are mixed with each fiber F constituting the fiber bundles F1 and F2, thereby forming a continuous mixed yarn (see FIG. 4).

As illustrated in FIGS. 1 and 2, regarding the braider 10, the core material 100 is relatively transferred in the axial direction M with respect to the supporting member 12, and the impellers 15 are rotated, which causes the respective bobbin carriers 14A and 14B to run along the running track W1 (W2), thereby winding the respective fiber bundles F1 and F2, which is laid between the respective bobbin carriers 14A and 14B and the core material 100, around the outer circumferential surface of the core material 100.

Next, the heating device 30 will be described.

As illustrated in FIG. 5, regarding the heating device 30, the respective fiber bundles F1 and F2 are heated, and the thermoplastic resin bonded to the respective fiber bundles Fl and F2 is fused. Regarding the heating device 30, the thermoplastic resin bonded to the respective fiber bundles F1 and F2 is fused in a predetermined heating area X (a first area X1 and a second area X2).

The tension T of each tension applying device 18 is applied to the respective fiber bundles F1 and F2 in the heating area X. The heating area X of the present embodiment is an area inclusive of a destination position P1, at which the respective fiber bundles F1 and F2 supplied from the braider 10 reach the outer circumferential surface of the core material 100, and the periphery of the destination position P1. For example, the heating area X is an area between a position P2 situated immediately before the respective fiber bundles F1 and F2 reach the outer circumferential surface of the core material 100 and a position P3 at which the respective fiber bundles F1 and F2 go around the axis of the core material 100 from the destination position P1.

The heating area X is constituted by the first area X1 and the second area X2.

The first area X1 is an area in which the tension T of each tension applying device 18 is applied to the respective fiber bundles F1 and F2, out of areas where the respective fiber bundles F1 and F2 are wound around the outer circumferential surface of the core material 100 by the braider 10. In the first area X1, the tension T of each tension applying device 18 is applied to the respective fiber bundles F1 and F2, thereby providing the respective fiber bundles F1 and F2 with a compaction force. The compaction force means a fastening force generated by pulling the respective fiber bundles F1 and F2 by means of the tension T of each tension applying device 18, whereby the respective fiber bundles F1 and F2 are fastened on the outer circumferential surface of the core material 100.

When the thermoplastic resin bonded to the respective fiber bundles F1 and F2 is fused in the first area X1, the respective fiber bundles F1 and F2 are impregnated with the fused thermoplastic resin, and simultaneously the compaction force is provided for the area where the fused thermoplastic resin is impregnated. Accordingly, this restrains the emergence of space between the fibers constituting the fiber bundle F1 (F2) and makes it possible to restrain the emergence of a gap between the fiber bundle F1 (F2) and the outer circumferential surface of the core material 100.

The second area X2 is an area situated immediately before the respective fiber bundles F1 and F2 supplied from the braider 10 reach the outer circumferential surface of the core material 100. When the thermoplastic resin bonded to the respective fiber bundles F1 and F2 is fused in the second area X2, the respective fiber bundles F1 and F2 reach the first area X1 in a state of being bonded to the fused thermoplastic resin, and when the respective fiber bundles F1 and F2 have reached the first area X1, the compaction force is provided for the respective fiber bundles F1 and F2. Accordingly, this restrains the emergence of space between the fibers constituting the fiber bundle F1 (F2) and makes it possible to restrain the emergence of a gap between the fiber bundle F1 (F2) and the outer circumferential surface of the core material 100.

Regarding the fiber structure forming apparatus 1, the thermoplastic resin bonded to the respective fiber bundles F1 and F2 is fused by the heating device 30 in the heating area X, and the compaction force is provided for the respective fiber bundles F1 and F2 in the heating area X, thereby forming a fiber structure 110 from the respective fiber bundles F1 and F2. Accordingly, the fiber structure 110 can be formed without using a metal mold, and the fiber structure 110 can be easily formed.

The fiber structure 110 is formed on the outer circumferential surface of the core material 100 and has a cylindrical shape along the outer circumferential surface of the core material 100. The impregnated thermoplastic resin is cooled and cured, so that the fiber structure 110 is cylindrically cured into a state of completion. Regarding the fiber structure 110, a reinforced fiber layer is formed on the outer circumference of the core material 100, which achieves improvement in the pressure-resistant property of the core material 100.

Regarding the device disclosed in Patent Document 1 (Japanese Unexamined Patent Application Publication No. 1995-9597) described in Description of the Related Art, the fiber structure made up of the fiber bundles is heated and formed by use of a heat forming device. However, the heat forming device includes a metal mold (die member) and is large in size. Accordingly, it has been difficult for the braider to bring close to the supply position of the fiber bundle with respect to the area where heat forming is performed by the heat forming device. Consequently, the heat forming device is separated from the supply position of the fiber bundle for the braider and heats the fiber bundles in an area where the compaction force is not generated. As a result, when the thermoplastic resin bonded to the fiber bundle is fused, space between the fibers constituting the fiber bundle emerges, and a gap between the fiber bundle and the outer circumferential surface of the core material appears.

Hereinafter, the tape-member winding device 31 will be described.

As illustrated in FIG. 6A, regarding the fiber structure forming apparatus 1, it may be constituted that, after the fiber structure 110 is formed, a tape member 32 is wound around the outer circumferential surface of the fiber structure 110 by means of the tape-member winding device 31. The tape member 32, for example, is of a metal tape. The tape member 32 is constituted of materials that are not melted at a melting point of the thermoplastic resin.

The tape-member winding device 31 winds the tape member 32 around the outer circumferential surface of the fiber structure 110 in a predetermined winding area G. The winding area G is an area where the thermoplastic resin, with which the fiber structure 110 is impregnated, is fused. For example, the winding area G is an area disposed immediately following the heating area X (see FIGS. 5 and 6A). This is because it is conceivable that the state of fusion of the thermoplastic resin, with which the fiber structure 110 is impregnated, is maintained immediately after the heating area X.

As illustrated in FIGS. 6A and 6B, the tape member 32 is spirally wound in the axial direction M of the core material 100 and wound in such a manner as to include portions on which the adjacent tape members 32 are overlapped to each other. Accordingly, it is possible to wind the tape member 32 around the outer circumferential surface of the fiber structure 110 without gaps.

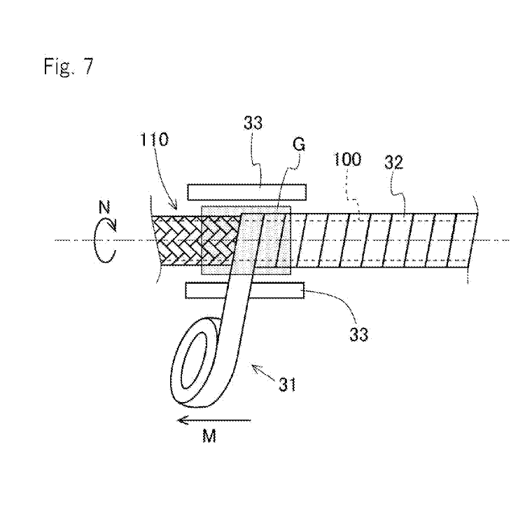

As illustrated in FIG. 7, it may be constituted that a new heating device 33 is provided, and the tape member 32 is wound around the outer circumferential surface of the fiber structure 110 by means of the tape-member winding device 31 while the fiber structure 110 is heated by the new heating device 33. In this case, the new heating device 33 and the tape-member winding device 31 are installed on the outer side of the fiber structure 110. Then, the core material 100 is rotated in an axis rounding direction N while the new heating device 33 and the tape-member winding device 31 are transferred in the axial direction M. Accordingly, the thermoplastic resin, with which the fiber structure 110 is impregnated, is fused by the new heating device 33, thereby forming the winding area G, and the tape member 32 is wound around the outer circumferential surface of the fiber structure 110 by means of the tape-member winding device 31 in the winding area G (see FIG. 7). It may be constituted that the heating device is provided on the inner side of the core material 100, and the fiber structure 110 is heated by the heating device from the inside of the core material 100, and the thermoplastic resin, with which the fiber structure 110 is impregnated, is fused.

With the above-mentioned constitution, when the tape member 32 is wound around the fiber structure 110 by means of the tape-member winding device 31, the surplus portion of the fiber structure 110 is pushed out by the tape member 32 and bulged on the outer-side portion of the tape member 32. This makes it possible to arrange the outer circumferential surface of the fiber structure 110 in a flat form. It is noted that, after completion of winding the tape member 32, the end portion 110′ of the fiber structure 110, which includes a bulging portion Fα disposed on the outer-side portion of the tape member 32, is cut and removed as an unnecessary portion (see FIG. 6B). Furthermore, the tape member 32 is wound around the outer circumferential surface of the fiber structure 110, so that the fiber structure 110 can be steadily impregnated with the thermoplastic resin, thereby making it possible to steadily suppress the emergence of air bubbles or portions, in which the fiber structure 110 is not impregnated with the thermoplastic resin, in the interior of the fiber structure 110.

### Second Embodiment

Hereinafter, a fiber structure forming apparatus 2, which is a second embodiment of the fiber structure forming apparatus, will be described.

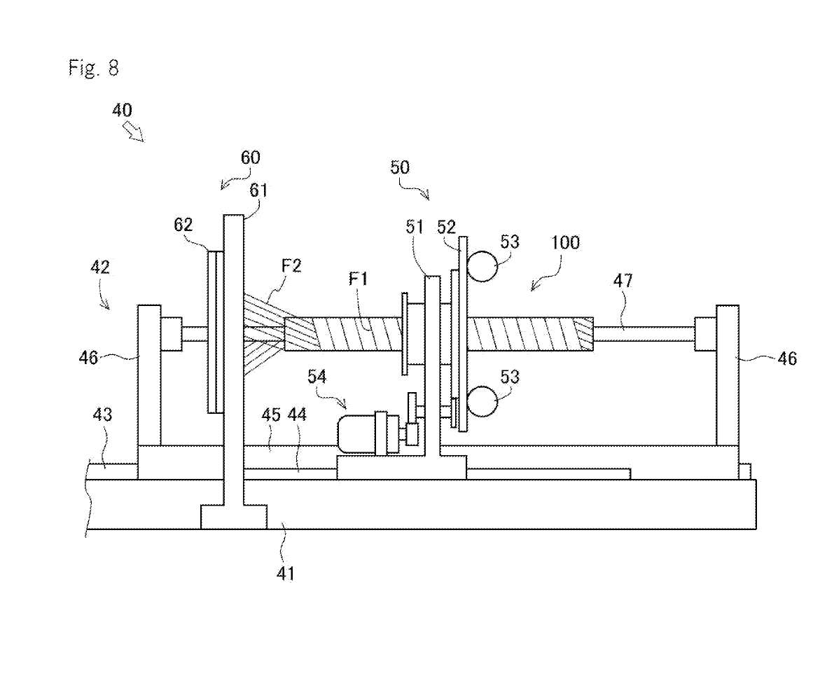

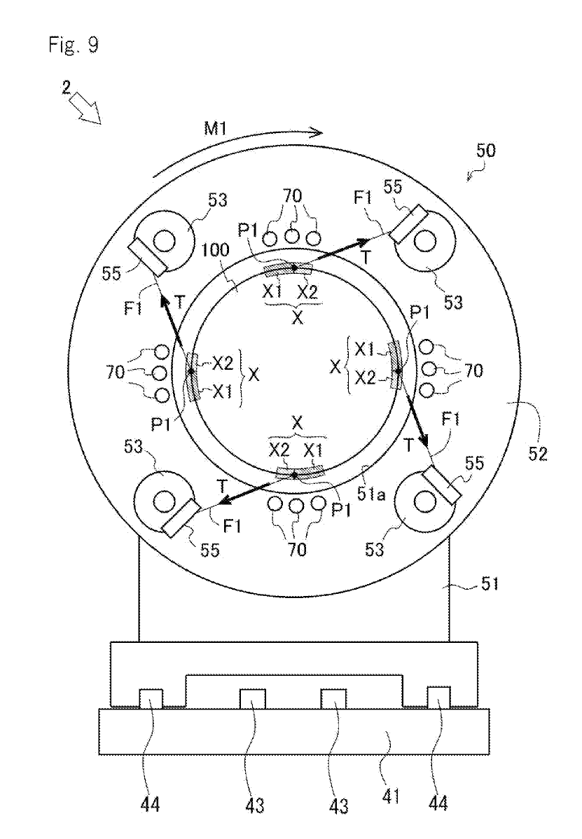

The fiber structure forming apparatus 2 includes a hoop winding device 50 of a filament winding device 40, a tension applying device 55, a heating device 70, and a tape-member winding device (see FIGS. 8 and 9).

First, the filament winding device 40 will be described.

As illustrated in FIG. 8, the filament winding device 40 includes a base 41, a supporting portion 42, the hoop winding device 50, and a helical winding device 60.

A first rail 43 that guides the cylindrical core material 100 and a second rail 44 that guides the hoop winding device 50 are provided on the base 41. The core material 100 described in the present embodiment is a pipe, but the present invention is not limited to this. A hollow container such as a tank may be applied to the core material 100.

The supporting portion 42 includes a base 45, supporting stands 46, and a rotary shaft 47. The base 45 is arranged above the first rail 43 and constituted in such a manner that the first rail 43 is slidably moved. A base drive device (not illustrated) that slides the base 45 is connected to the base 45. The base drive device is constituted by a motor, an air cylinder or a hydraulic cylinder. The supporting stands 46 are arranged above the base 45. The rotary shaft 47 is arranged between the supporting stands 46. A rotary shaft drive device (not illustrated) that rotates the rotary shaft 47 is connected to the rotary shaft 47. The rotary shaft drive device is constituted by the motor or the like. The core material 100 is mounted on the rotary shaft 47.

The hoop winding device 50 performs hoop winding. In the hoop winding, the winding angle of the fiber bundles F1 is positioned approximately vertical to the axis of the core material 100. As illustrated in FIGS. 8 and 9, the hoop winding device 50 includes a hoop frame 51 and a wrapping table 52. The hoop frame 51 engages the second rail 44. A hole 51a through which the core material 100 can be passed is formed in the hoop frame 51. A frame drive device (not illustrated) that slides the hoop frame 51 is connected to the hoop frame 51. The frame drive device is constituted by the motor, the air cylinder or the hydraulic cylinder. The wrapping table 52 is rotatably mounted on the hoop frame 51. A bobbin 53 around which the fiber bundle F1 is wound and a guiding member (not illustrated) that guides the fiber bundle F1 on the bobbin 53 to the core material 100 are provided on the wrapping table 52. A table drive device 54 that rotates the wrapping table 52 about the axis of the core material 100 is connected to the wrapping table 52. The table drive device 54 is constituted by the motor or the like.

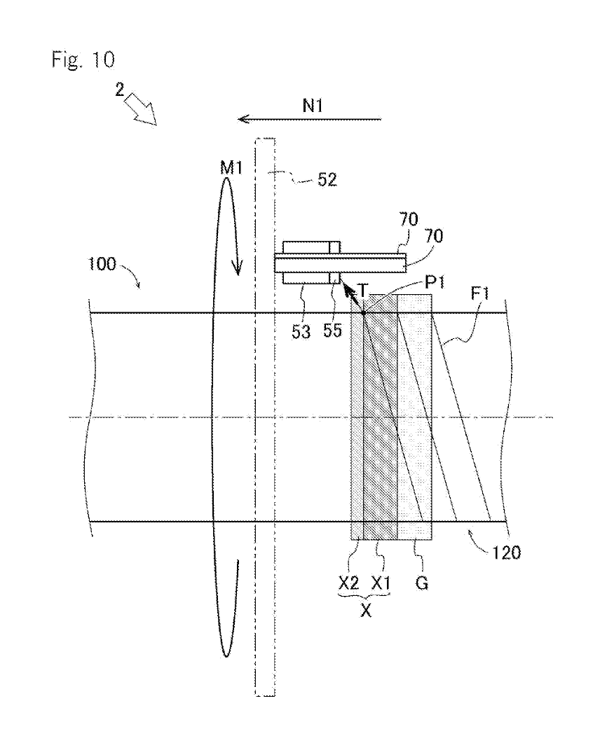

Tension applying devices 55 that apply the tension T to each fiber bundle F1 are provided in the hoop winding device 50. For example, the constitution of the tension applying device 55 is the same as that of the tension applying device 18 of the first embodiment (see FIG. 3). As illustrated in FIGS. 9 and 10, when the hoop winding is performed by the hoop winding device 50, each tension applying device 55 applies the tension T to each fiber bundle Fl, which runs from the hoop winding device 50 to the core material 100, in the direction opposite to the running direction of each fiber bundle F1. Accordingly, this prevents each fiber bundle F1 from slackening. The hoop winding device 50 winds each fiber bundle F1 around the outer circumferential surface of the core material 100 while each tension applying device 55 applies the tension T to the fiber bundle F1.

The hoop winding of the hoop winding device 50 is performed in the following procedures. First, each fiber bundle F1 is drawn out from the bobbin 53 and fixed on the core material 100 with an adhesive tape. Subsequently, the frame drive device and the table drive device 54 are activated, whereby the wrapping table 52 is rotated about the axis of the core material 100 while being slid in the axial direction of the core material 100. In the present embodiment, the wrapping table 52 is rotated about the axis of the core material 100 in one-side direction Ml while being slid in one-side direction N1 of the axial direction of the core material 100 (see FIGS. 9 and 10). Then, the core material 100 passes through the hole 51a of the hoop frame 51, thereby winding each fiber bundle F1 around the outer circumferential surface of the core material 100.

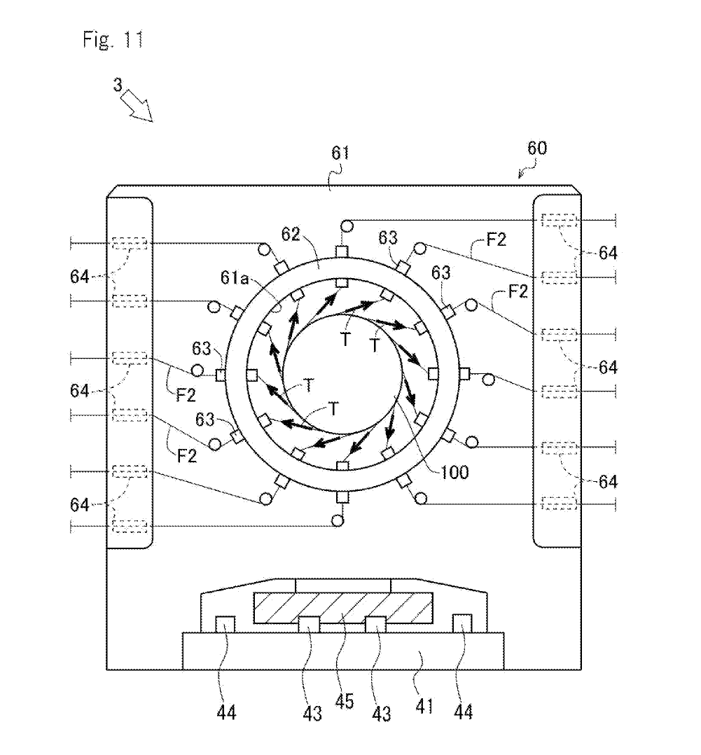

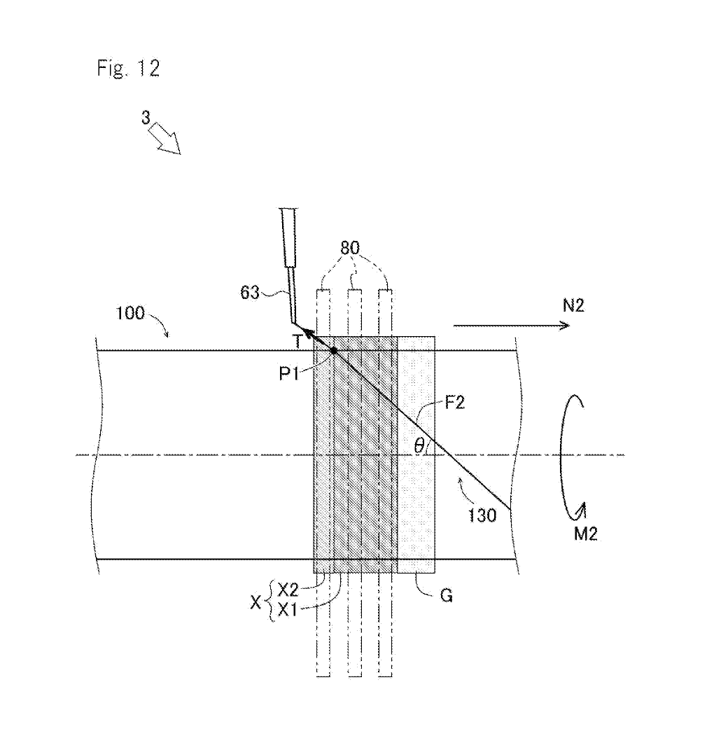

The helical winding device 60 performs helical winding. In the helical winding, the winding angle of the fiber bundles F2 corresponds to a predetermined value 0 with respect to the axis of the core material 100 (see FIG. 12). As illustrated in FIGS. 8 and 11, the helical winding device 60 includes a helical frame 61 and a helical head 62. The helical frame 61 erects from the base 41 and has a hole 61a through which the core material 100 passes. The helical head 62 is provided on the helical frame 61. The helical winding device 60 of the present embodiment has the single helical head 62, but may include a plurality of helical heads 62.

A plurality of yarn path guides 63 are provided in the helical head 62. The yarn path guides 63 are arranged in parallel to each other in the circumferential direction of the hole 61a. The yarn path guides 63 are members that guide the fiber bundles F2 to the outer circumference of the core material 100 and are formed in a cylindrical shape that allows the fiber bundles F2 to pass through. The fiber bundle F2 on each bobbin not illustrated is supplied to each yarn path guide 63.

As illustrated in FIG. 11, tension applying devices 64 that apply the tension T to each fiber bundle F2 are provided in the helical winding device 60. For example, the tension applying device 64 is constituted by a known nip-type tension mechanism. When the helical winding is performed by the helical winding device 60, each tension applying device 64 applies the tension T to each fiber bundle F2, which runs from the helical winding device 60 to the core material 100, in the direction opposite to the running direction of each fiber bundle F2. Accordingly, this prevents each fiber bundle F2 from slackening. The helical winding device 60 winds each fiber bundle F2 around the outer circumferential surface of the core material 100 while each tension applying device 64 applies the tension T to the fiber bundle F2.

The helical winding of the helical winding device 60 is performed in the following procedures. First, each fiber bundle F2 is drawn out via each yarn path guide 63 and fixed on the core material 100 with an adhesive tape. Subsequently, the base drive device and the rotary shaft drive device are activated, whereby the core material 100 is rotated about the axis thereof while being transferred in the axial direction. In the present embodiment, the core material 100 is rotated about the axis thereof in other-side direction M2 while being transferred in other-side direction N2 of the axial direction (see FIGS. 11 and 12). Then, the core material 100 passes through the hole 61a of the helical frame 61, thereby winding each fiber bundle F2 around the outer circumferential surface of the core material 100.

The thermoplastic resin is bonded to the fiber bundles F1 and F2. The constitution of the fiber bundles F1 and F2 of the second embodiment is the same as that of the fiber bundles F1 and F2 of the first embodiment. Accordingly, its detailed description is omitted (see FIG. 4).

Next, a heating device 70 will be described.

As illustrated in FIGS. 9 and 10, the heating device 70 is fixed on the wrapping table 52 of the hoop winding device 50 and rotated with the wrapping table 52. The heating device 70 heats each fiber bundle Fl, thereby fusing the thermoplastic resin bonded to the fiber bundle Fl. Regarding the heating device 70, the thermoplastic resin bonded to each fiber bundle F1 is fused in a predetermined heating area X (the first area X1 and the second area X2).

The tension T of each tension applying device 55 is applied to the fiber bundle F1 in the heating area X. The heating area X of the present embodiment is an area inclusive of the destination position P1, at which each fiber bundle F1 supplied from the hoop winding device 50 reaches the outer circumferential surface of the core material 100, and the periphery of the destination position P1.

The heating area X is constituted by the first area X1 and the second area X2.

The first area X1 is an area in which the tension T of each tension applying device 64 is applied to each fiber bundle Fl, out of areas where the respective fiber bundles F1 are wound around the outer circumferential surface of the core material 100 by the hoop winding device 50. In the first area X1, the tension T of each tension applying device 64 is applied to the respective fiber bundles F1, thereby providing the respective fiber bundles F1 with the compaction force. The compaction force means a fastening force generated by pulling each fiber bundle F1 by means of the tension T of each tension applying device 55, whereby the respective fiber bundles F1 are fastened on the outer circumferential surface of the core material 100.

When the thermoplastic resin bonded to each fiber bundle F1 is fused in the first area X1, each fiber bundle F1 is impregnated with the fused thermoplastic resin, and simultaneously the compaction force is provided for the area where the fused thermoplastic resin is impregnated. Accordingly, this restrains the emergence of space between the fibers constituting the fiber bundle F1 and makes it possible to restrain the emergence of a gap between the fiber bundle F1 and the outer circumferential surface of the core material 100.

The second area X2 is an area situated immediately before each fiber bundle F1 supplied from the hoop winding device 50 reaches the outer circumferential surface of the core material 100. When the thermoplastic resin bonded to each fiber bundle F1 is fused in the second area X2, each fiber bundle F1 reaches the first area X1 in a state of being bonded to the fused thermoplastic resin, and when the fiber bundle F1 has reached the first area X1, the compaction force is provided for the fiber bundle F1. Accordingly, this restrains the emergence of space between the fibers constituting the fiber bundle F1 and makes it possible to restrain the emergence of a gap between the fiber bundle F1 and the outer circumferential surface of the core material 100.

Regarding the fiber structure forming apparatus 2, the thermoplastic resin bonded to each fiber bundle F1 is fused by the heating device 70 in the heating area X, and the compaction force is provided for each fiber bundle F1 in the heating area X, thereby forming a fiber structure 120 from each fiber bundle F1. Accordingly, the fiber structure 120 can be formed without using a metal mold, and the fiber structure 120 can be easily formed. It is noted that the process of forming the fiber structure 120 is represented by use of one fiber bundle F1 in FIG. 10 for the convenience of the description.

The fiber structure 120 is formed on the outer circumferential surface of the core material 100 and has a cylindrical shape along the outer circumferential surface of the core material 100. The impregnated thermoplastic resin is cooled and cured, so that the fiber structure 120 is cylindrically cured into a state of completion. Regarding the fiber structure 120, a reinforced fiber layer is formed on the outer circumference of the core material 100, which achieves the improvement in the pressure-resistant property of the core material 100.

Regarding the fiber structure forming apparatus 2, it may be constituted that, after the fiber structure 120 is formed, the tape member is wound around the outer circumferential surface of the fiber structure 120 by means of the tape-member winding device. The constitution of the tape member and the tape-member winding device of the second embodiment is the same as that of the tape member and the tape-member winding device of the first embodiment. Also, the tape-member winding device of the second embodiment winds the tape member based on the procedures similar to those of the tape-member winding device 31 of the first embodiment (see FIGS. 6A to 7). The tape-member winding device winds the tape member around the outer circumferential surface of the fiber structure 120 in the predetermined winding area G. The winding area G is an area where the thermoplastic resin, with which the fiber structure 120 is impregnated, is fused. For example, the winding area G is an area disposed immediately following the heating area X (see FIGS. 6A and 10). It may be constituted that a new heating device is provided, and the tape member is wound around the outer circumferential surface of the fiber structure 120 by means of the tape-member winding device while the fiber structure 120 is heated by the new heating device (see FIG. 7). The tape-member winding device is provided, so that the same action and effect can be achieved as in the first embodiment, in which the tape-member winding device 31 is provided.

### Third Embodiment

Hereinafter, a fiber structure forming apparatus 3, which is a third embodiment of the fiber structure forming apparatus, will be described.

The fiber structure forming apparatus 3 includes the helical winding device 60 of the filament winding device 40, the tension applying device 64, the heating device 80, and the tape-member winding device.

The constitution of the filament winding device 40 and the helical winding device 60 of the third embodiment is the same as that of the filament winding device and the helical winding device of the second embodiment. Accordingly, its detailed description is omitted.

As illustrated in FIG. 12, the heating device 80 heats each fiber bundle F2, thereby fusing the thermoplastic resin bonded to the fiber bundle F2. Regarding the heating device 80, the thermoplastic resin bonded to each fiber bundle F2 is fused in the predetermined heating area X (the first area X1 and the second area X2).

The tension T of each tension applying device 64 is applied to the fiber bundle F2 in the heating area X. The heating area X of the present embodiment is an area inclusive of the destination position P1, at which each fiber bundle F2 supplied from the helical winding device 60 reaches the outer circumferential surface of the core material 100, and the periphery of the destination position P1.

The heating area X is constituted by the first area X1 and the second area X2.

The first area X1 is an area in which the tension T of each tension applying device 64 is applied to each fiber bundle F2, out of areas where the respective fiber bundles F2 are wound around the outer circumferential surface of the core material 100 by the helical winding device 60. In the first area X1, the tension T of each tension applying device 64 is applied to the respective fiber bundles F2, thereby providing the respective fiber bundles F2 with the compaction force. The compaction force means a fastening force generated by pulling each fiber bundle F2 by means of the tension of each tension applying device 64, whereby the respective fiber bundles F2 are fastened on the outer circumferential surface of the core material 100.

When the thermoplastic resin bonded to each fiber bundle F2 is fused in the first area X1, each fiber bundle F2 is impregnated with the fused thermoplastic resin, and simultaneously the compaction force is provided for the area where the fused thermoplastic resin is impregnated. Accordingly, this restrains the emergence of space between the fibers constituting the fiber bundle F2 and makes it possible to restrain the emergence of a gap between the fiber bundle F2 and the outer circumferential surface of the core material 100.

The second area X2 is an area situated immediately before each fiber bundle F2 supplied from the helical winding device 60 reaches the outer circumferential surface of the core material 100. When the thermoplastic resin bonded to each fiber bundle F2 is fused in the second area X2, each fiber bundle F2 reaches the first area X1 in a state of being bonded to the fused thermoplastic resin, and when the fiber bundle F2 has reached the first area X1, the compaction force is provided for the fiber bundle F2. Accordingly, this restrains the emergence of space between the fibers constituting the fiber bundle F2 and makes it possible to restrain the emergence of a gap between the fiber bundle F2 and the outer circumferential surface of the core material 100.

Regarding the fiber structure forming apparatus 3, the thermoplastic resin bonded to each fiber bundle F2 is fused by the heating device 80 in the heating area X, and the compaction force is provided for each fiber bundle F2 in the heating area X, thereby forming a fiber structure 130 from each fiber bundle F2. Accordingly, the fiber structure 130 can be formed without using the metal mold, and the fiber structure 130 can be easily formed. It is noted that the process of forming the fiber structure 130 is represented by use of one fiber bundle F2 in FIG. 12 for the convenience of the description.

The fiber structure 130 is formed on the outer circumferential surface of the core material 100 and has a cylindrical shape along the outer circumferential surface of the core material 100. The impregnated thermoplastic resin is cooled and cured, so that the fiber structure 130 is cylindrically cured into a state of completion. Regarding the fiber structure 130, a reinforced fiber layer is formed on the outer circumference of the core material 100, which achieves the improvement in the pressure-resistant property of the core material 100.

Regarding the fiber structure forming apparatus 3, it may be constituted that, after the fiber structure 130 is formed, the tape member is wound around the outer circumferential surface of the fiber structure 130 by means of the tape-member winding device. The constitution of the tape member and the tape-member winding device of the third embodiment is the same as that of the tape member and the tape-member winding device of the first embodiment. The tape-member winding device of the third embodiment winds the tape member based on the procedures similar to those of the tape-member winding device 31 of the first embodiment (see FIGS. 6A to 7). The tape-member winding device winds the tape member around the outer circumferential surface of the fiber structure 130 in the predetermined winding area G. The winding area G is an area where the thermoplastic resin, with which the fiber structure 130 is impregnated, is fused. For example, the winding area G is an area disposed immediately following the heating area X (see FIGS. 6A and 12). It may be constituted that a new heating device is provided, and the tape member is wound around the outer circumferential surface of the fiber structure 130 by means of the tape-member winding device while the fiber structure 130 is heated by the new heating device (see FIG. 7). The tape-member winding device is provided, so that the same action and effect can be achieved as in the first embodiment, in which the tape-member winding device 31 is provided.

1. A fiber structure forming apparatus comprising:
a winding device configured to wind a fiber bundle, to which thermoplastic resin is bonded, around an outer circumferential surface of a core material;
a tension applying device, when the fiber bundle is wound around the outer circumferential surface of the core material by the winding device, configured to apply tension to the fiber bundle that runs from the winding device to the core material; and
a heating device configured to fuse the thermoplastic resin bonded to the fiber bundle in a predetermined heating area in which the tension of the tension applying device acts on the fiber bundle.

2. The fiber structure forming apparatus according to claim 1,
wherein the heating area is an area inclusive of a destination position, at which the fiber bundle supplied from the winding device reaches the outer circumferential surface of the core material, and a periphery of the destination position.

3. The fiber structure forming apparatus according to claim 1,
wherein the winding device is any of a braider, a hoop winding device of a filament winding device, or a helical winding device of the filament winding device.

4. The fiber structure forming apparatus according to claim 1,
wherein the thermoplastic resin bonded to the fiber bundle is fused by the heating device in the heating area, and a compaction force, with which the fiber bundle is fastened on the outer circumferential surface of the core material by means of the tension of the tension applying device, is applied to the fiber bundle in the heating area, thereby forming a fiber structure from the fiber bundle.

5. The fiber structure forming apparatus according to claim 4, further comprising a tape-member winding device configured to wind a tape member around the outer circumferential surface of the fiber structure in a predetermined winding area in which the thermoplastic resin impregnated in the fiber structure is fused.
